(19) United States
(12) Patent Application Publication
(10) Pub. No.: US 2025/0386825 A1
(43) Pub. Date: Dec. 25, 2025

(54) Formulation for Applying to Vegetation

(71) Applicant: Okipa Ltd, London (GB)

(72) Inventor: John Russell Clearwater, Auckland (NZ)

(21) Appl. No.: 19/224,532

(22) Filed: May 30, 2025

Related U.S. Application Data
(63) Continuation of application No. PCT/EP2023/083719, filed on Nov. 30, 2023.

(30) Foreign Application Priority Data
Dec. 1, 2022 (GB) 2218087.1

(51) Int. Cl. A01N 43/80; A01N 25/06; A01N 25/30; A01N 43/04; A01P 13/00

(52) U.S. Cl. CPC A01N 43/80; A01N 25/06; A01N 25/30; A01N 43/04; A01P 13/00

(57) ABSTRACT

A formulation for applying to vegetation is provided, wherein the formulation comprises at least one sugar or sugar substitute and at least one spreader adjuvant, wherein the spreader adjuvant comprises a silicone surfactant. Also provided is a method of killing or controlling the growth of weeds, comprising applying the formulation of the invention to the weed, or a method of pre-harvest crop desiccation, comprising applying the formulation of invention to the crop, optionally to a haulm of the crop. The formulation may be provided as a kit of parts, wherein the kit comprises the sugar or sugar substitute and the spreader adjuvant. A method of preparing the formulation is provided, comprising the step of mixing the sugar or sugar substitute and the spreader adjuvant.

### PRIORITY DATA

This application is a bypass continuation of International Application Serial No. PCT/EP2023/083719, filed on Nov. 30, 2023, which claims the benefit of GB Application Serial No. 2218087.1, filed on Dec. 1, 2022, all of which are incorporated herein by reference.

### TECHNICAL FIELD

The present invention relates to formulations for applying to vegetation, in particular for use in methods of controlling the growth of vegetation, such as by killing or controlling the growth of weeds, or for pre-harvest crop desiccation and drying.

### BACKGROUND OF THE INVENTION

Controlling the growth of vegetation is important for agriculture where the aim is typically to grow crops or pastures of a single species, or a mixture of a few desired species. Growth of weeds in an agricultural setting may reduce crop yield, crop quality, potential for storage, or even kill the desired crop.

Herbicides are used to control the growth of vegetation. The herbicide may be applied to a specific weed or sprayed over a crop as a whole. An example of a herbicide is glyphosate, which is a broad-spectrum systemic herbicide and crop desiccant discovered by Monsanto chemist John E. Franz in 1970. In 2007, glyphosate was the most used herbicide in the United States' agricultural sector. Glyphosate is absorbed through foliage, and minimally through roots, and transported to growing points. It works by inhibiting a plant enzyme involved in the synthesis of three aromatic amino acids: tyrosine, tryptophan, and phenylalanine. It is therefore effective only on actively growing plants.

However, concerns over the use of herbicides have been raised, for example in causing herbicide residues in food or for more general environment reasons. While glyphosate has been approved by various regulatory bodies, concerns have persisted about its potentially harmful effects on humans and the environment. A survey of British wheat in 2006-2008 found average levels of 0.05-0.22 mg/kg glyphosate with maximum levels of 1.2 mg/kg. In July 2013 Austria banned the use of pre-harvest glyphosate citing the precautionary principle. In April 2015, oat buyers in Western Canada announced that they were refusing oats in which pre-harvest glyphosate had been used.

It is therefore desirable to develop new formulations for applying to vegetation and methods of controlling the growth of vegetation that are environmentally friendly and safe for use on foods.

Previous attempts have been made to provide environmentally friendly herbicides. For example, WO 2021/191614 discloses a method for controlling the growth of vegetation including a step of applying a composition to the foliage of the vegetation, without pre-heating, where the composition includes an aqueous solution of at least one sugar, and optionally a penetrant such as Validate®, to induce osmosis on cells of foliage. This causes water within the cells of the plant vegetation to cross the cell's walls, inducing plasmolysis (contraction of the protoplast of the cell due to loss of water from the cell) which leads to cell death. This sugar-based solution may be advantageous in that it is non-toxic to the environment and any run-off from the foliage is relatively limited. However, challenges still remain in improving the delivery and effectiveness of such sugar-based formulations.

For example, formulations may be provided with adjuvants in order to modify herbicidal activity or application characteristics. Agricultural adjuvants are not themselves active in controlling or killing weeds. Instead, these additives modify some property of the formulation.

An example of an adjuvant that may be added to a herbicide formulation is a penetrant, such as those of WO 2021/191614, which is used if the penetration and translocation of the herbicide into the inside of the plant is needed to improve pesticide absorption and performance. For example, a penetrant may dissolve or penetrate waxy layers on leaves and allow the herbicide to interact with plant tissue. Petroleum oils, vegetable oils, or modified vegetable oils are common penetrator adjuvants.

However, utilizing adjuvants to improve a particular attribute of a formulation may be unpredictable and may come with other disadvantages. For example, some low surface tension formulations are ineffective at adhering to a plant, whereas some are better at promoting uptake via the plant's stomata or otherwise. This may result in formulations that require a relatively long rain-free period, which do not spread well, or which can be expensive to manufacture or apply. Some formulations may also be better suited to specific uses, such as treating actively growing weeds or treating crops pre-harvest.

Accordingly, a need remains to provide further formulations for applying to vegetation and methods of controlling the growth of vegetation that are environmentally friendly and safe for use on foods. with improved delivery and effectiveness.

### SUMMARY OF THE INVENTION

In a first embodiment, the invention provides a formulation for applying to vegetation, wherein the formulation comprises at least one sugar or sugar substitute and at least one spreader adjuvant, wherein the spreader adjuvant comprises a silicone surfactant.

In a second embodiment, the invention provides a method of killing or controlling the growth of weeds, comprising applying the formulation of the invention to the weed.

In a third embodiment, the invention provides a method of pre-harvest crop desiccation, comprising applying the formulation of the invention to the crop, optionally to a haulm of the crop.

In a fourth embodiment, the invention provides a kit of parts for preparing a formulation for applying to vegetation, wherein the kit comprises at least one sugar or sugar substitute and at least one spreader adjuvant, wherein the spreader adjuvant comprises a silicone surfactant.

In a fifth embodiment, the invention provides a method of preparing a formulation for applying to vegetation, comprising the steps of mixing at least one sugar or sugar substitute and at least one spreader adjuvant, wherein the spreader adjuvant comprises a silicone surfactant.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

A better understanding of the present subject matter can be obtained when the following detailed description of various embodiments is considered in conjunction with the following drawings, in which:

FIG. 1 shows the wetting of a leaf by water with a trisiloxane surfactant (lower part) and without a trisiloxane surfactant (upper part).

FIG. 2 shows brown wilt with a formulation of the invention comprising 0.1 vol % Silwet Gold one day after application.

FIG. 3 shows strong brown wilt (>50%) with a formulation of the invention comprising 0.5 vol % Silwet Gold one day after application.

FIG. 4 shows a comparison of sodium saccharin (NaS) 80 g/L formulations using different adjuvants.

FIG. 5 shows desiccation of potatoes by sodium saccharin (left: untreated, middle: 160 g/L, right: 320 g/L).

### DEFINITIONS

The term “adjuvant” is used herein according to the definition given in European Regulation (EC) 1107/2009 concerning the placing of plant protection products on the market, which defines adjuvants as being “substances or preparations which consist of co-formulants or preparations containing one or more co-formulants, in the form in which they are supplied to the user and placed on the market to be mixed by the user with a plant protection product and which enhance its effectiveness or other pesticidal properties.”

The term “spreader” or “spreader adjuvant” is used herein to refer to an adjuvant that allows the formulation to spread over a larger area of a target compared to no spreader.

The term “sugar or sugar substitute” is used herein to encompass natural sugars, sugar substitutes and sugar alcohols, as well as salts thereof. Without wishing to be bound by theory, the sugar or sugar substitute may be considered osmotically active on plant surfaces in that it may induce osmosis on cells of foliage to cause movement of water within the cells of the plant vegetation to cross the cell's walls inducing plasmolysis (contraction of the protoplast of the cell due to loss of water from the cell). Additionally or alternatively, the sugar or sugar substitute may inhibit photosynthesis and break down chloroplasts in the targeted plant vegetation.

The term “natural sugar” is used herein to refer to simple sugars (monosaccharides) and compound sugars (disaccharides) obtained from a natural source, e.g. plants, algae, milk etc.

The term “sugar substitute” is used herein to refer to products that have a substantially sweet taste but which not strictly categorised or chemically defined as a natural sugar (e.g. artificial sweeteners). Examples may be derived from natural plant sources or can be chemically formulated (e.g. synthetic sugar substitutes).

The term “sugar alcohol” is used herein to refer to an organic compound usually derived from a natural sugar and containing one hydroxyl group (—OH) attached to each carbon atom. Sugar alcohols may also be termed polyhydric alcohols, polyalcohols, alditol or glycitol.

The term “silicone surfactant” is used herein to refer to silicones/polysiloxanes having surfactant (e.g. amphiphilic) properties. Examples include silicone polyethers, dimethicone copolyol, trisiloxane alkoxylate, polyetherdimethylsiloxane (PEMS), and polyether-polymethylsiloxan-copolymers.

### DETAILED DESCRIPTION

Specific embodiments of the invention will now be described further by way of example only. Many other embodiments falling within the scope of the accompanying claims will be apparent to the skilled reader. Therefore, although the present invention is described in connection with the following preferred embodiments, it is to be understood that other similar embodiments may be used or modifications or additions may be made to the described embodiments for performing the same function of the present invention without deviating therefrom. Therefore, the present invention should not be limited to any single embodiment, but rather construed in breadth and scope in accordance with the recitation of the appended claims.

Any feature that has been described above in relation to any one aspect or embodiment of the invention is also disclosed hereby in relation to all other aspects and embodiments. Likewise, all combinations of two or more of the individual features or elements described above may be present in any aspect or embodiment. For brevity, all possible features and combinations have not been recited in relation to all aspects and embodiments, but they are expressly contemplated and hereby disclosed.

In a first embodiment, the invention provides a formulation for applying to vegetation, wherein the formulation comprises at least one sugar or sugar substitute and at least one spreader adjuvant, wherein the spreader adjuvant comprises a silicone surfactant.

Surprisingly, the inventors discovered that improved delivery and effectiveness of the sugar- or sugar substitute-based formulation can be achieved by combining the osmotic and/or photosynthesis-adverse action of a sugar or sugar substitute with a spreader adjuvant.

Since the mode of action of the sugar or sugar substitute as an herbicide may be based on osmosis through the surface of the plant and/or the disruption of the photosynthesis of the plant, the inventors realised that spreading and homogeneous distribution of the formulation over the surface of the plant may help to support the efficacy of the formulation. This is in contrast, for example, to the penetration and translocation of other herbicides to the inside of the plant. For this reason, the spreader adjuvant of the present invention does not require any penetrant properties which is a significant advantage and allows for a better selection of available spreader adjuvants. Thus, in embodiments of the invention, the spreader adjuvant is not also a penetrant (i.e. not a spreader-penetrant or a surfactant-penetrant).

A spreader adjuvant (also termed a wetting agent) is a class of adjuvant comprised of chemical compounds that improve the emulsifying, dispersing, spreading, wetting, or other surface modifying properties of liquids. A spreader adjuvant thus allows the formulation to spread over a larger area of a target compared to no spreader.

The spreader adjuvant may also help to reduce the surface tension of spray droplets which prevents droplets from beading up on a leaf's surface. In other words, the spreader adjuvant may lower the spray droplet surface tension which enables the spray to increase the leaf area covered by each droplet. Good wetting may lead to improved coverage of plant surfaces and good herbicide or desiccation activity.

Surprisingly, the inventors discovered that a silicone surfactant spreader adjuvant is particularly advantageous for this application compared to other adjuvants, as discussed in the examples below.

Silicone surfactants were found to decrease the surface tension of the formulation to much lower values in comparison to conventional adjuvants. This results in significantly enhanced spreading of the formulation over treated plant surfaces which carries the formulation to morphologically complex and thus difficult-to-reach parts of the plant. In embodiments, the silicone surfactant is not a surfactant penetrant.

Examples of silicone surfactants include silicone polyethers, polyether modified polysiloxanes, dimethicone copolyol, and trisiloxane surfactants such as trisiloxane alkoxylate, polyether modified trisiloxane, polyetherdimethylsiloxane (PEMS), heptamethyltrisiloxane, polyether-polymethylsiloxan-copolymers, and combinations thereof.

The silicone surfactant may be nonionic, anionic, cationic or zwitterionic. For example, cationic silicone surfactants may be advantageous to provide additional antibacterial properties. Anionic silicone surfactants may be advantageous to provide low toxicity, antibacterial properties, hard water resistance, and/or good compatibility with other surfactants. Nonionic silicone surfactants may be advantageous to provide low surface tension, high thermal stability, improved water resistance, chemical inertness, low volatility and/or low-foaming properties. Zwitterionic silicone surfactants may be advantageous to provide combinations of the aforementioned properties. In one embodiment, the silicone surfactant is a nonionic silicone surfactant, such as a non-ionic silicone polyether or non-ionic trisiloxane.

Particularly preferred silicone surfactants in the invention are trisiloxane surfactants, such as trisiloxane alkoxylate, polyetherdimethylsiloxane (PEMS), polyether-polymethylsiloxan-copolymers, or combinations thereof.

Examples of preferred silicone surfactants are SILWET GOLD™, BREAK-THRU® S240, BREAK-THRU® OE 446, BREAK-THRU® S 301, BREAK-THRU® SD 260, and SYLGARD™ OFX-0309 FLUID, or combinations thereof.

Trisiloxane surfactants are referred to as “superspreaders” or “superwetters” which enhance the activity and the rain fastness of the formulation by promoting rapid spreading over the hydrophobic surfaces of leaves. The structural formula of three example trisiloxane surfactants is shown below.

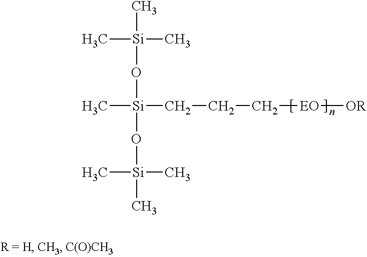

Polyetherdimethylsiloxanes (PEMS) are copolymers containing a siloxane backbone with one or more methyl groups on the silicon atom substituted with a polyoxyalkylene (polyether) group. These organosilicon copolymers have a permethylated siloxane backbone, with one or more methyl groups on the silicon replaced by polyoxyalkylene groups, such as polyoxyethylene, polyoxypropylene or polyoxybutylene. Unlike most organofunctional silicones, which may contain only a few % of some organic functionality, the hybrid copolymer PEMS molecule is extensively modified and will usually have from 30-80% polyoxyalkylene content by weight.

SILWET GOLD™ is an organosilicone adjuvant comprising trisiloxane alkoxylate manufactured by UPL. It is classed as a spreader/superspreader adjuvant and acts by decreasing the surface tension of spray solutions to much lower values, in comparison to conventional adjuvants.

BREAK THRU® S240 is a non-ionic trisiloxane organosilicone formulation containing polyether-polymethylsiloxan-copolymer manufactured by Evonik Industries.

BREAK-THRU® OE 446 is a polyether modified polysiloxane formulation manufactured by Evonik Operations GmbH.

BREAK-THRU® S 301 is a polyethersiloxane formulation containing oxirane, 2-methyl-, polymer with oxirane, mono [3-[1,3,3,3-tetramethyl-1-[(trimethylsilyl)oxy]-1-disiloxanyl]propyl] ether manufactured by Evonik Corporation.

BREAK-THRU® SD 260 is a polyether modified trisiloxane formulation containing oxirane, 2-methyl-, polymer with oxirane, mono [3-[1,3,3,3-tetramethyl-1-[(trimethylsilyl)oxy]-1-disiloxanyl]propyl]ether manufactured by Evonik Corporation.

SYLGARD™ OFX-0309 FLUID is a low molecular weight non-ionic silicone polyether surfactant manufactured by The Dow Chemical Company.

Preferably, the spreader adjuvant may be present in an amount of about 0.1-0.6% by volume of the aqueous solution, or according to the manufacturer guidelines.

Alternatively, the spreader adjuvant is present in an amount of about 0.025-0.1% by volume of the aqueous solution, or according to the manufacturer guidelines.

The sugar or sugar substitute of the invention may provide an osmotic action on plant surfaces in that it induces osmosis on cells of foliage to cause movement of water within the cells of the plant vegetation to cross the cell's walls inducing plasmolysis (contraction of the protoplast of the cell due to loss of water from the cell). Additionally or alternatively, the sugar or sugar substitute of the invention may provide a biophysical action on plant surfaces in that it interrupts the photosynthesis of the cells chloroplast, thus destroying the plant's capability to metabolize water, nutrients and CO₂, which causes significant damage to the leaves and the root system.

Conveniently, the sugar or sugar substitute may be provided in the form of a natural sugar, optionally selected from the group consisting of sucrose, glucose, fructose, galactose, maltose, arabimose, lactose, inositol, mannose, ribose, trehalose, xylose, salts thereof, and combinations thereof.

Conveniently, the sugar or sugar substitute may be provided in the form of a sugar substitute, optionally selected from the group consisting of saccharin, Stevia rebaudiana, Siraitia grosvenori, aspartame, acesulfame, sucralose, neotame, advantame, salts thereof, and combinations thereof.

Conveniently, the sugar or sugar substitute may be provided in the form of a sugar alcohol, optionally selected from the group consisting of sorbitol, xylitol, lactitol, mannitol, erythritol, maltitol, salts thereof, and combinations thereof.

In some embodiments, the sugar or sugar substitute may comprise a combination of sugars, such as a combination of a natural sugar, a sugar substitute, and/or a sugar alcohol.

In preferred embodiments, the sugar or sugar substitute comprises saccharin.

Saccharin (also known as saccharine; preferred IUPAC name

1H-1λ⁶,2-Benzothiazole-1,1,3 (2H)-trione) is known for use as an artificial sweetener and may be used in products such as drinks, candies, cookies and to mask the bitter taste of some medicines. Saccharin has the following structural formula.

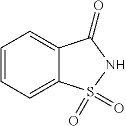 [SMILES: O=C1NS(=O)(=O)c2ccccc21]

In particularly preferred embodiments, the sugar or sugar substitute comprises a saccharin salt. In its acid form, saccharin is not particularly water-soluble. However, salts of saccharin (such as sodium, potassium, lithium, and calcium saccharin) in their crystalline form can be used in an aqueous solution which is particularly useful for spraying in agricultural use. A preferred salt of the invention is sodium saccharin. An example is sodium saccharin dihydrate having the following structural formula (where x=2 providing dihydrate).

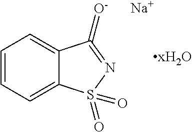

As noted above, the sugar or sugar substitute (particularly sugar or sugar substitute salt) and spreader adjuvant are advantageously provided in an aqueous solution, which is particularly useful in agriculture. The aqueous solution may be easily and economically formulated, may be non-toxic, and may be convenient for spraying using conventional agricultural equipment.

The term “formulation” and “aqueous solution” as used herein should be understood such that the aqueous solution is a component of the formulation as a whole. Thus, whilst the sugar or sugar substitute and spreader adjuvant may be in aqueous solution, other components may be present in the formulation either in aqueous solution, or in some other form of mixture such as a suspension, dispersion, emulsion, powder mix, etc.

Preferably, the aqueous solution may have a concentration of sugar or sugar substitute in the range of about 1-400 g/L, optionally in the range of about 1-200 g/L, optionally in the range of about 5-180 g/L, optionally in the range of about 30-160 g/L, optionally in the range of about 50-120 g/L. Preferably, the sugar or sugar substitute is a saccharin salt, such as sodium saccharin.

For agricultural uses, a formulation having about 30-150 g/L sugar or sugar substitute may be applied to vegetation equivalent to a dosage of about 10-100 kg/ha (about 1-10 g/m²). A formulation having about 50-120 g/L sugar or sugar substitute may be applied equivalent to a dosage of about 20-50 kg/ha (about 2-5 g/m²).

Optionally, the formulation may further comprise additional components, actives and/or adjuvants, such as a sticker, penetrant, emulsifier, humectant, defoamer, drift control agent, deposition aide, water conditioner, acidifier, buffer, colorant, insecticide, plant growth regulator, biological, micronutrient, fertilizer, sophorolipid, or combination thereof.

In a second embodiment, the invention provides a method of killing or controlling the growth of weeds, comprising applying the formulation of the invention to the weed. It has been found that the combination of at least one sugar or sugar substitute and at least one spreader adjuvant, wherein the spreader adjuvant comprises a silicone surfactant, is particularly efficacious for killing or controlling growth of vegetation and weeds as a broadband herbicide.

In a third embodiment, the invention provides a method of pre-harvest crop desiccation, comprising applying the formulation of the invention to the crop, optionally to a haulm of the crop.

Pre-harvest crop desiccation refers to the application of an agent to a crop just before harvest to kill the leaves and/or plants so that the crop dries out more quickly and evenly, thus giving the farmer control over the decision for harvesting.

Examples of crops suitable for pre-harvest crop desiccation include cereals or grains such as barley, oats, rice, sorghum (millet) and wheat; flax; cotton; legumes such as beans (e.g. fava beans), lentils, peas, and soybeans; maize (corn); mustard; oilseed such as canola, linseed, rapeseed, safflower, sunflower, and soy; potato; sugarcane; and sunflower. Examples of action for potato desiccation are provided in the examples below.

Crop desiccation may provide various advantages to improve the efficiency and economics of mechanical harvesting.

For example, desiccation can improve the uniformity of a crop, helping to correct for uneven crop growth that may be a problem in northern climates, during wet summers, or when weed control is poor. Plants that have naturally reached the end of their maturation may be mingled with plants in earlier stages of growth, which may need to be controlled and regulated by desiccation.

Desiccation may also improve uniformity of moisture content in grain, which has positive economic benefits in the storage and price of the grain. In grain crops such as wheat, barley and oats, uniformly dried crops do not have to be windrowed (swathed and dried) prior to harvest but can be easily straight-cut and harvested. This saves the farmer time and money, which may be especially important in northern regions where the growing season is short.

In a non-food crop such as cotton, reliance on natural frost may be too late to be effective in some regions. Leaves that remain on the cotton plant may thus interfere with mechanical harvesters and stain the white cotton resulting in a lower quality grade. Herbicides which cause both defoliation and desiccation may reduce these problems.

Desiccation may also enhance the ripening of a crop. For example, sugarcane or grain ripeness may be made more uniform by pre-harvest crop desiccation.

For pre-harvest crop desiccation of potatoes, which is a particularly preferred application of the invention, desiccation may artificially induce the skin maturation process to provide defined quality characteristics at certain points in time with good potato skin firmness so that the potatoes are more easily transportable and storable. Mechanical methods (haulm topping) are typically costly and can lead to quality losses. Chemical desiccation has been used, such as with diquat (Reglone), but this was banned in Europe in 2019 for toxicity reasons. Similarly effective and economically usable chemical substitutes have not been available and the combination of mechanical and thermal methods is economically and energetically very problematic. As demonstrated by the examples below, the formulation of the invention shows particularly advantageous utility for pre-harvest crop desiccation of potatoes.

The formulation of the invention may thus provide various advantages for pre-harvest crop desiccation. The harvest may be conducted earlier, weed control may be initiated for a future crop, ripening may be earlier which allows for earlier replanting, and green material may be reduced in the harvest putting less strain on harvesting machinery, all with reduced environmental impact.

As a herbicide or for crop desiccation, the formulation may be sprayed onto vegetation at a rate and quantity sufficient to wet the majority or all of the vegetation to be treated, e.g. the foliage or haulm thereof. For example, the sugar or sugar substitute of the invention may applied to the weed or crop in an amount of about 10-100 kg/hectare (about 1-10 g/m²), optionally about 20-50 kg/hectare (about 2-5 g/m²). Preferably, the sugar or sugar substitute is a saccharin salt, optionally sodium saccharin such as sodium saccharin dihydrate.

The formulation of the invention may be provided pre-mixed ready for use, or as a concentrate intended to be diluted, typically with water, prior to application. Alternatively, the formulation may be provided as a “tank-mix” in the form of a kit, optionally in the form of dry powder to be mixed with water.

Thus, in a fourth embodiment, the invention provides a kit of parts for preparing a formulation for applying to vegetation, wherein the kit comprises at least one sugar or sugar substitute and at least one spreader adjuvant, wherein the spreader adjuvant comprises a silicone surfactant.

In a fifth embodiment, the invention provides a method of preparing a formulation for applying to vegetation, comprising the steps of mixing at least one sugar or sugar substitute and at least one spreader adjuvant, wherein the spreader adjuvant comprises a silicone surfactant.

In the aforementioned method, the at least one sugar or sugar substitute and at least one spreader adjuvant may be mixed in aqueous solution, which is particularly convenient for agricultural use such as by spraying.

Optionally, the at least one sugar or sugar substitute and at least one spreader adjuvant may be mixed by a user at the point of use in a spray tank for agriculture.

Thus, the sugar or sugar substitute and spreader adjuvant may be included in a pre-mixed formulation, or they may be provided as a kit to be mixed extemporaneously in a tank, optionally with other ingredients and adjuvants, such as in the tank of an agricultural spraying equipment. When the sugar or sugar substitute and spreader adjuvant are included pre-mixed in the formulation, they are referred to as an “in-can”. However, the sugar or sugar substitute and spreader adjuvant may also be added separately when a spray solution is being prepared. In this case, sugar or sugar substitute and spreader adjuvant are referred to as a “tank mix”. Where there is limited storage space, restricted transport options, or limited compatibility in a formulation, it may be advantageous to use a tank mix.

Accordingly, the following applications of the present invention are conceivable:
a) desiccation of potatoes and cover crops
b) vegetation control on railways and hard surfaces (e.g. invasive neophytes)
c) control of problem weeds in grassland (dock, thistle, warty cabbage, etc.)
d) pre-emergence treatment of weeds in sugar beet, maize and vegetable crops
e) inter-row treatment of weeds in sugar beet, maize and other row crops
f) late application in maize and potatoes.

### EXAMPLES

Examples of the invention will be provided below with reference to the Figures, in which:

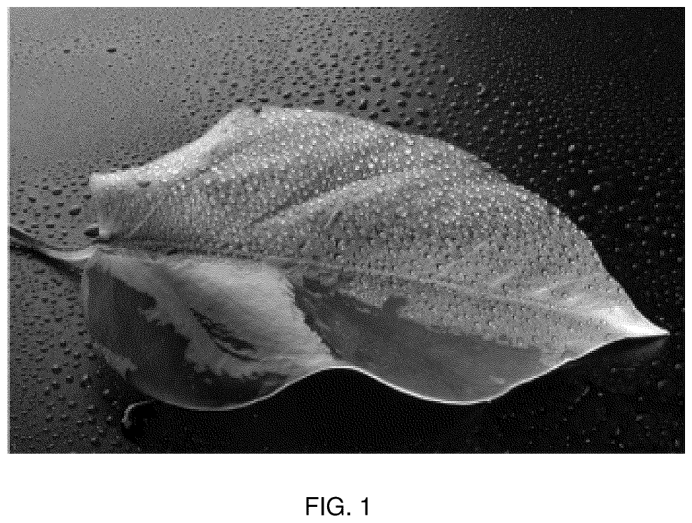

FIG. 1 shows the wetting of a leaf by water with a trisiloxane surfactant (lower part) and without a trisiloxane surfactant (upper part).

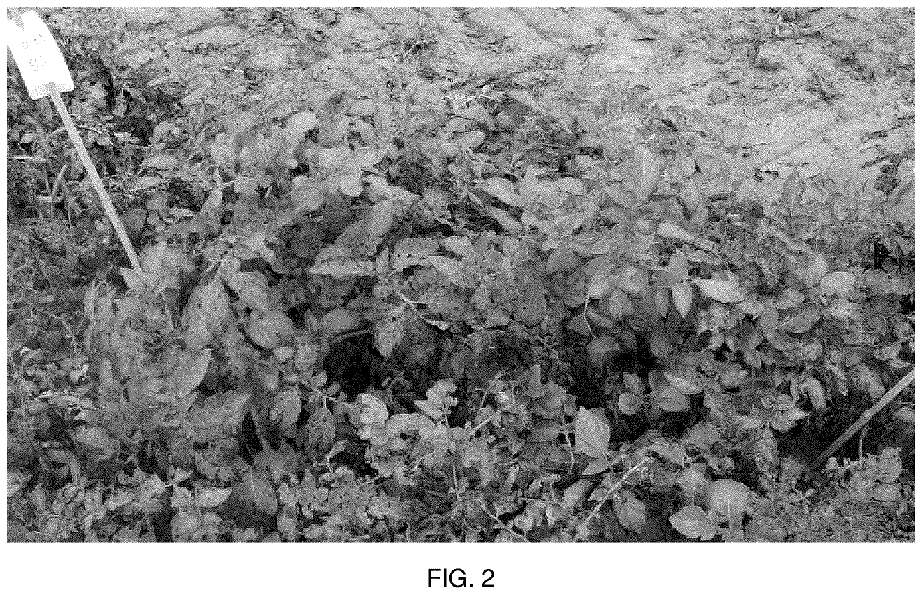

FIG. 2 shows brown wilt with a formulation of the invention comprising 0.1 vol % Silwet Gold one day after application.

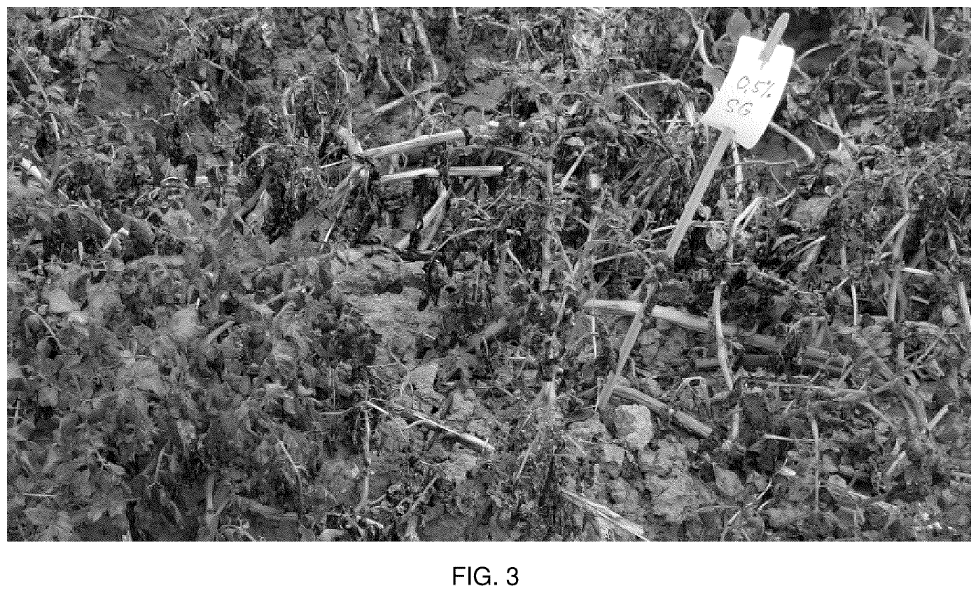

FIG. 3 shows strong brown wilt (>50%) with a formulation of the invention comprising 0.5 vol % Silwet Gold one day after application.

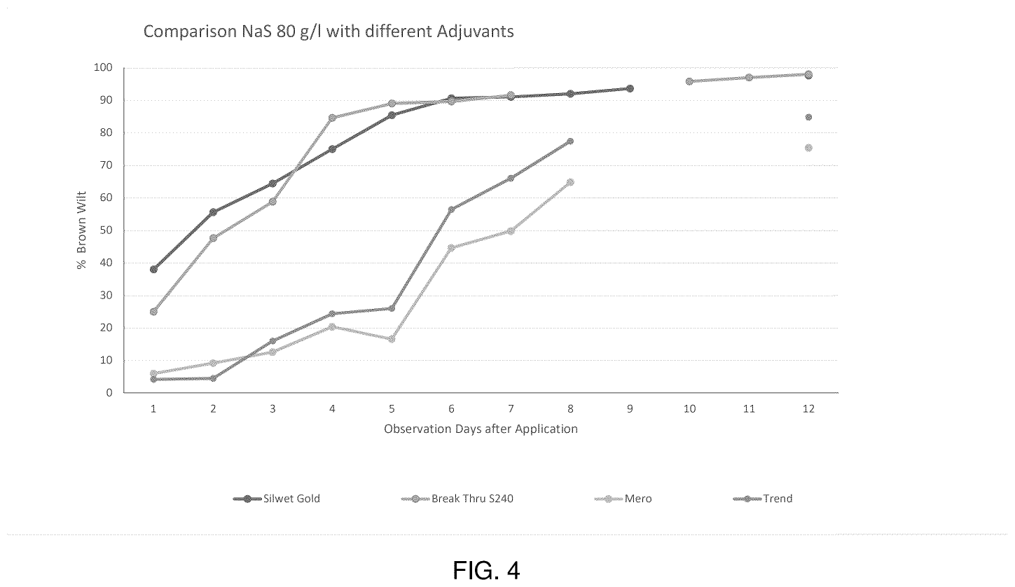

FIG. 4 shows a comparison of sodium saccharin (NaS) 80 g/L formulations using different adjuvants.

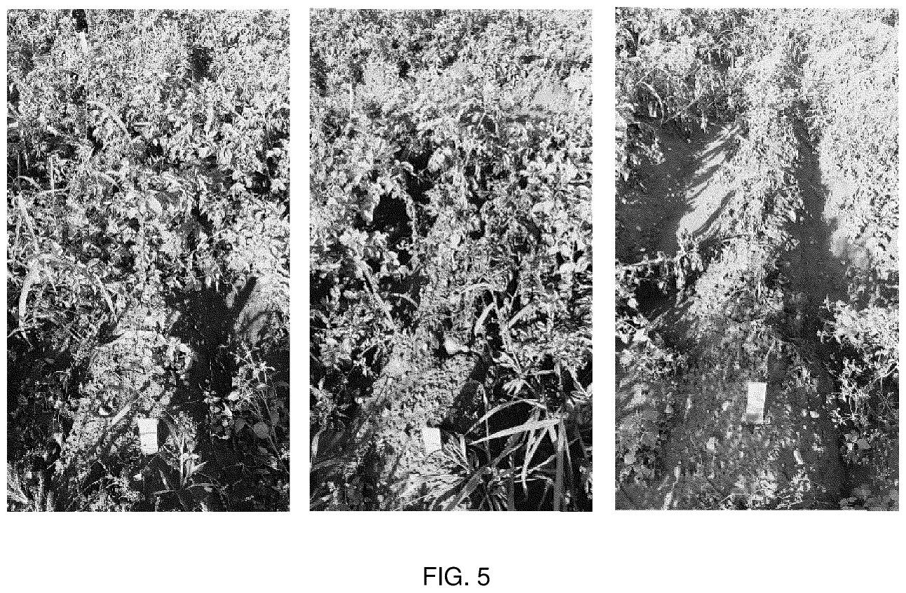

FIG. 5 shows desiccation of potatoes by sodium saccharin (left: untreated, middle: 160 g/L, right: 320 g/L)

### Example 1

As discussed above, a spreader adjuvant may help to reduce the surface tension of spray droplets which prevents droplets from beading up on a leaf's surface. In this way, the spreader adjuvant may lower the spray droplet surface tension which enables the spray to increase the leaf area covered by each droplet. This property of spreader adjuvants is demonstrated in FIG. 1, which shows the wetting of a leaf by water with a trisiloxane surfactant spreader adjuvant (lower part) and without (upper part). As seen in this Figure, the lower portion of the leaf using a trisiloxane surfactant spreader adjuvant has greater coverage by water with less or substantially no beading of droplets.

### Example 2

Experiments were conducted to demonstrate the efficacy of formulations of the invention using a combination of sugar or sugar substitute and silicone surfactant spreader adjuvant, and to identify the preferred concentration of silicone surfactant spreader adjuvant to be used.

Formulations were prepared containing sodium saccharin and Silwet Gold in aqueous solution. Silwet Gold is a silicone surfactant (organosilicone) adjuvant comprising trisiloxane alkoxylate manufactured by UPL. It is classed as a spreader/superspreader adjuvant and acts by decreasing the surface tension of spray solutions to much lower values, in comparison to conventional adjuvants.

FIG. 2 shows successful brown wilt with the example formulation comprising sodium saccharin and 0.1 vol % Silwet Gold one day after application.

FIG. 3 shows stronger brown wilt (>50%) with the example formulation comprising 0.5 vol % Silwet Gold one day after application.

Based on the above experiments, it is concluded that formulations of the invention show successful herbicidal activity and may act as crop desiccants. On this basis, suitable concentrations of silicone surfactant spreader adjuvant were identified in the range of 0.1-0.6% or 0.025-0.1% by volume of the aqueous solution.

### Example 3

Comparative experiments were conducted to compare of efficacy in herbicidal action causing brown wilt, as well as for potato desiccation, of the combination of an aqueous solution of sodium saccharin 80 g/L with different adjuvants. Two spreader adjuvants of a silicone surfactant class (Silwet Gold and Break Thru S240) were compared against two other adjuvants (Mero and Trend).

Silwet Gold is a silicone surfactant (organosilicone) adjuvant comprising trisiloxane alkoxylate manufactured by UPL. It is classed as a spreader/superspreader adjuvant and acts by decreasing the surface tension of spray solutions to much lower values, in comparison to conventional adjuvants.

Break Thru S240 is a non-ionic surfactant and belongs to the chemical class of organomodified trisiloxanes. It comprises a liquid concentrate formulation containing 75.0% w/w trisiloxane organosilicone copolymers manufactured by Evonik Industries.

Mero is an agricultural/horticultural/industrial penetrant adjuvant manufactured by Bayer. It comprises an emulsifiable concentrate of oil (rapeseed fatty acid esters) and ethoxy (7) tridecanol.

Trend (Trend 90) is a professional growth regulator and penetrant adjuvant manufactured by Dupont™, which comprises an emulsifiable concentrate of ethoxylated isodecyl alcohol.

All adjuvants were applied with the same dosage of 0.5 vol % in aqueous solution with sodium saccharin. As seen in FIG. 4, the higher performance of the silicone surfactant spreaders (Silwet Gold and Break Thru S240) is clearly visible. In this particular use, a brown wilt above 90-95% after 12 days was found particularly desirable.

### Example 4

In addition to the direct control of weeds in arable farming and on non-crop land, the use of sodium saccharin for desiccation of potatoes was examined. Thus, the following variants were tested in a field test (soil type: sandy loam): (a) untreated, (b) 160 g/l and (c) 320 g/l sodium saccharin. In this example, the addition of an additive was deliberately avoided in order to assess the specific effect of sodium saccharin. The experimental design was a fully randomized block design with 3 replicates and a plot size of 2.25 m².

In each case, a row of potatoes 3 m in length was applied using a 5 l hand-held sprayer (®Gloria) with a conventional annular nozzle at a pressure of 3-4 bar. As a result, the degree of damage was recorded in the form of the following rating score.

### Rating Scores and Corresponding Damage (%) Based on Visual Assessment

| rating score | damage (%) |
|---|---|
| 0 | 0-10 |
| 1 | 11-20 |
| 2 | 21-30 |
| 3 | 31-40 |
| 4 | 41-50 |
| 5 | 51-60 |
| 6 | 61-70 |
| 7 | 71-80 |
| 8 | 81-90 |
| 9 | 91-98 |
| 10 | 99-100 |

The trend showed that the potato leaves can be sufficiently desiccated with sodium saccharin. However, the variation within the test blocks was considered high. FIG. 5 shows an example of the effect on the potato (photo from Aug. 16, 2022, 11 days after the treatment).

As expected, the higher concentration of sodium saccharin resulted in partial or complete destruction of the potato leaves more quickly, as follows:

Score (damage) of the potato leaves after treatment with Sodium saccharin (treatment on Aug. 5, 2022, Braunschweig, conventional cultivation)

| | damage on | damage on | damage on |
|---|---|---|---|
| variant | Aug. 8, 2022 | Aug. 16, 2022 | Aug. 22, 2022 |
| untreated | 0.3 | 1.3 | 3.3 |
| 160 g/l Sodium | 1.3* | 5.3* | 8.3* |
| saccharin | | | |
| 320 g/l Sodium | 3.3* | 7.7* | 9.3* |
| saccharin | | | |

*significant difference compared to untreated (p < 0.05)

Nevertheless, even with the low concentration, after 17 days there was also sufficient desiccation, but with variation of the individual values. It can be assumed that certain parts of the plant did not react phenotypically despite extensive treatment, because the plants were not completely wetted. The use of a spreader adjuvant, particularly a spreader adjuvant comprising a silicone surfactant, would therefore be beneficial.

1. A formulation for use on vegetation, comprising at least one sugar or sugar substitute and at least one spreader adjuvant including a silicone surfactant.

2. The formulation of claim 1, wherein the formulation is herbicidal.

3. The formulation of claim 1, wherein the formulation is effective to induce pre-harvest crop desiccation.

4. The formulation of claim 1, wherein the sugar is a member selected from the group consisting of sucrose, glucose, fructose, galactose, maltose, arabimose, lactose, inositol, mannose, ribose, trehalose, xylose, salts thereof, and combinations thereof.

5. The formulation of any claim 1, wherein the sugar substitute is a member selected from the group consisting of saccharin, Stevia rebaudiana, Siraitia grosvenori, aspartame, acesulfame, sucralose, neotame, advantame, salts thereof, and combinations thereof.

6. The formulation of claim 1, wherein the sugar substitute comprises a sugar alcohol.

7. The formulation of claim 1, wherein the sugar or sugar substitute comprises a combination of a natural sugar, a sugar substitute, and/or a sugar alcohol.

8. The formulation of claim 1, wherein the sugar or sugar substitute comprises saccharin or a salt thereof.

9. The formulation of claim 8, wherein the saccharin salt is a member selected from the group consisting of lithium saccharin, sodium saccharin, potassium saccharin, calcium saccharin and combinations thereof.

10. The formulation of claim 1, wherein the silicone surfactant is a nonionic, anionic, cationic or zwitterionic silicone surfactant.

11. The formulation of claim 1, wherein the silicone surfactant is not a surfactant-penetrant.

12. The formulation of claim 1, wherein the silicone surfactant is a member selected from the group consisting of a silicone polyether, polyether modified polysiloxane, dimethicone copolyol, trisiloxane surfactant, trisiloxane alkoxylate, polyether modified trisiloxane, polyetherdimethylsiloxane (PEMS), heptamethyltrisiloxane, a polyether-polymethylsiloxan-copolymer, and combinations thereof.

13. The formulation of claim 1, where the sugar or sugar substitute and spreader adjuvant are in an aqueous solution.

14. The formulation of claim 13, wherein the aqueous solution has a concentration of sugar or sugar substitute in the range of about 1-400 g/L.

15. The formulation of claim 14, wherein the sugar or sugar substitute is sodium saccharin.

16. The formulation of claim 1, wherein the spreader adjuvant is present in an amount of about 0.025-0.6% by volume of the aqueous solution.

17. (canceled)

18. The formulation of claim 1, wherein the formulation further comprises a sticker, penetrant, emulsifier, humectant, defoamer, drift control agent, deposition aid, water conditioner, acidifier, buffer, colorant, insecticide, plant growth regulator, biological, micronutrient, fertilizer, or combination thereof.

19. A method of controlling vegetation growth comprising applying a formulation as recited in claim 1 to the vegetation.

20. The method of claim 19, wherein the vegetation is a crop and application results in pre-harvest crop desiccation or the vegetation is a weed and application results in killing the weed.

21. The method of claim 20, wherein the crop is selected from the group consisting of cereals or grains such as barley, oats, rice, sorghum (millet) and wheat; flax; cotton; legumes, lentils, peas, and soybeans; maize (corn); mustard; oilseed; potato; sugarcane; and sunflower.

22. The method of claim 19, wherein sugar or sugar substitute is applied to the vegetation in an amount of about 10-100 kg/hectare (about 1-10 g/m²), optionally about 20-50 kg/hectare (about 2-5 g/m²).

23. The method of claim 22, wherein the sugar or sugar substitute is sodium saccharin.

24. A system for preparing a formulation as recited in claim 1, suitable for application to vegetation, the system comprising at least one sugar or sugar substitute component and at least one spreader adjuvant having a silicone surfactant separated from the at least one sugar or sugar substitute component.

25. A method of preparing a formulation as recited in claim 1, comprising the steps of combining the at least one sugar or sugar substitute and at least one spreader adjuvant having a silicone surfactant.

26. The method of claim 25, wherein the at least one sugar or sugar substitute and at least one spreader adjuvant are mixed in aqueous solution.

27. The method of claim 25, wherein the at least one sugar or sugar substitute and at least one spreader adjuvant are combined at the point of use in a spray tank for agricultural use.
